(19) United States
(12) Patent Application Publication
(10) Pub. No.: US 2026/0274696 A1
(43) Pub. Date: Sep. 17, 2026

(54) SYSTEM FOR PRODUCING TECHNICAL GRADE AMMONIUM NITRATE AND METHOD OF PRODUCING THEREOF

(71) Applicant: Yara International ASA, Oslo (NO)

(72) Inventor: Bernard LAURENT, Lustin (BE)

(21) Appl. No.: 19/165,609

(22) PCT Filed: May 3, 2024
(86) PCT No.: PCT/EP2024/062188

§ 371 Date: Sep. 16, 2025

(30) Foreign Application Priority Data
May 3, 2023 (NO) 20230519

(51) Int. Cl. C01C 1/18; B01J 19/24; C05C 1/02; H05B 6/64

(52) U.S. Cl. CPC C01C 1/185; B01J 19/24; C05C 1/02; H05B 6/64; B01J 2219/00024; C01P 2006/10

(57) ABSTRACT

A method and system for producing ammonium nitrate particles having a density ranging from 650.0 g/l to 850.0 g/l and a porosity ranging from 6.0% to 14.0%, wherein ammonium nitrate particles, including at least 0.350% by weight of water, having a density above 850.0 g/l and having a porosity below 6.0%, are heated using microwave energy with a frequency ranging from 300.0 MHz to 300.0 GHz, thereby decreasing the density and increasing the porosity of the ammonium nitrate particles.

### FIELD

The present disclosure relates to the field of production of technical grade ammonium nitrate.

### BACKGROUND

Ammonium nitrate (AN) is an important raw material for industrial explosives besides its use as a fertiliser. AN based industrial explosives normally consists of Porous Ammonium Nitrate prills and Fuel Oil. This type is the dominating industrial explosive globally.

In general, ammonium nitrate acts as oxidiser and reacts with fuel oil after initiation. The oil is normally absorbed in pores in the AN.

The pores/inner voids in ammonium nitrate porous prills (AN-PP) serve two purposes. First, the volume and size distribution of open pores should be sufficiently able to absorb and retain the proper amount of oil. Secondly, additional pores/inner voids are required to act as hot spots during detonation to facilitate propagation of the detonation front at a high velocity. The smaller the diameter of the borehole, the more important these inner voids become.

The higher the pore volume, the lower the bulk density becomes. Increasing the pore volume by conventional means normally results in reduced mechanical strength.

Ideally, an explosive consisting of the elements C, H, N and O should only give N₂, CO₂ and H₂O as reaction products from the detonation. However, as all such explosives are non-homogeneous, the detonation fumes will also consist of minor quantities of CO, NO and NO₂.

According to Romanian patent RO 116072, a synergistic mixture of modifying agents for the structure of the crystals and pore forming drying agents are introduced into the melt of ammonium nitrate at a temperature of 160° C. The total concentration of these additives is in the range of 0.4 to 1.0%. The porosity is 0.09 to 0.15%, allowing an intake of oil of 15 to 20%.

According to Russian patent RU 2121969 a ratio of 0.05 to 0.15% of molasses is added to the ammonium nitrate before the prilling process. The capacity of oil absorption is 9.7 to 13.5%. The prills show a high durability and they are claimed to be explosion-proof.

Porous prills of ammonium nitrate with a bulk density of 0.55 to 0.85 are available after Brazilian descriptions of invention in BR 9600121 and BR 9505880 by addition of chemical reagents inert to ammonium nitrate and generating gas, that will widen existing flaws and bubbles.

A problem with the production of ammonium nitrate on a commercial scale, from 100 to 1000 tons per day, relates to porous ammonium granules. The off-size granules, that is about 10% of the granules coming out of the granulation device, must be recycled, which causes dust emissions. Further, an about 96% by weight solution of ammonium nitrate, hence comprising about 4% by weight water, is used for producing porous granules. The rapid evaporation of water does not allow for suitable formation of pores and the use of additional water, that is a less concentrated solution of ammonium nitrate to form porous granules, results in fouling issues in the granulating equipment. The use of prills instead reduces the number of off-size particles, hence the extent to which recycling is needed. Also, the preparation of porous ammonium nitrate from prills allows for optimal porosity to be created without causing fouling, through the use of an about 96% by weight solution of ammonium nitrate, hence comprising about 4% by weight water.

In any event, producing porous ammonium nitrate involves heating and drying porous ammonium nitrate comprising in a fluid bed above 32° C. and then cool the dry product in air below 32° C., to achieve a product comprising 0.02 to 0.5% by weight water and at a temperature below 32° C. Repeated thermo-cycles across 32° C. provide the targeted porous material, however the process is time consuming as ammonium nitrate prills or granules have poor thermal conductivity. Further, the process is energy demanding considering the energy required for heating, drying and cooling. Further large quantity of humid air are required and once this air exits the process it requires treatment for dust removal and possibly water recovery for minimising the amount of water consumed for supplying the needed humid air.

Thus, a goal of this disclosure is to provide a system that reduces the amount of energy required for producing porous ammonium nitrate, this regardless of the non-porous ammonium nitrate starting material is granular or prilled. Another aim of the disclosure further is to present a system that possibly eliminates the requirement for a dryer and for a cooler—this means that the system should ideally allow for porous ammonium nitrate to be produced at the right water content and at the right temperature, such that it does not need to dried and cooled respectively, such as to achieve a reduction in the energy consumption but also simplification of the system, and also a lower footprint system. A further goal of this disclosure is to provide a system allowing for reduced reaction time for producing porous ammonium nitrate particles. In addition, the present disclosure aims at providing a safer and flexible system, that is a system that allows production of porous ammonium nitrate from a straight nitrogen fertilizer with a nitrogen content from 33 to 35% by weight nitrogen.

The alternative method should still not only produce the right volume of inner voids/pores of porous ammonium nitrate, but also the right size distribution of inner voids for increasing the initiation sensitivity, velocity of detonation and composition of the detonation fumes. This means that the method should still allow for the control of the pore distribution, the pore size and the pore size distribution.

### SUMMARY

In one aspect of the disclosure, a method for producing ammonium nitrate particles having a density ranging from 650.0 g/l to 850.0 g/l and a porosity ranging from 6.0% to 14.0% is disclosed. The method comprises the steps of:
a) providing ammonium nitrate particles comprising at least 0.350% by weight of water, having a density above 850.0 g/l and having a porosity below 6.0%; and
b) heating the ammonium nitrate particles using microwave energy with a frequency ranging from 300.0 MHz to 300.0 GHz, preferably ranging from 915.0 MHz to 22.0 GHz, thereby decreasing the density and increasing the porosity of the ammonium nitrate particles.

In one embodiment according to the method of the disclosure, the method further comprises the step of hydrating the ammonium nitrate particles with an aqueous solution prior to the heating step, thereby increasing the water content of the ammonium nitrate particles to a percentage of water above 0.350% by weight.

In one embodiment according to the method of the disclosure, the temperature of the ammonium nitrate particles during the heating step is maintained between 20.0° C. to 50.0° C.

In one embodiment according to the method of the disclosure, the duration of the heating step ranges between 10 seconds and 20 minutes.

In one embodiment according to the method of the disclosure, the heating step occurs in a continuous or a batchwise or discontinuous manner.

In one embodiment according to the method of the disclosure, the heating step occurs under vacuum or under atmospheric pressure conditions.

In one embodiment according to the method of the disclosure, the method further comprises the steps of:
A1) reacting ammonia and nitric acid in a reactor, thereby producing an ammonium nitrate solution;
A2) evaporating the ammonium nitrate solution, thereby producing an ammonium nitrate melt; and
A3) particulating the ammonium nitrate melt, thereby generating ammonium nitrate particles having a density above 850.0 g/l and having a porosity below 6.0%.

In one embodiment according to the method of the disclosure, during the heating step, an incoming air flow is used to control the temperature.

In one embodiment according to the method of the disclosure, the ammonium nitrate particles comprise between 33.0% and 35.0% by weight of nitrogen.

In one embodiment according to the method of the disclosure, the ammonium nitrate particles comprise between 0.30 to 0.50% by weight of a metal.

In one aspect of the disclosure, a system for preparing technical grade ammonium nitrate particles having a density ranging from 650.0 g/l to 850.0 g/l and a porosity ranging from 6.0% to 14.0%, is disclosed. The system comprises:
a reactor for reacting ammonia and nitric acid, thereby providing an ammonium nitrate solution;
an evaporator for evaporating the ammonium nitrate solution and producing an ammonium nitrate melt; and
a particulation system for particulating the ammonium nitrate melt and providing standard grade ammonium nitrate particles having a density above 850.0 g/l and having a porosity below 6.0%.

The system is characterised in that it further comprises a microwave heating system for heating the standard grade ammonium nitrate particles using electromagnetic radiation and providing microwave energy with a frequency ranging from 300.0 MHz to 300.0 GHz, preferably ranging from 915.0 MHz to 22.0 GHz, thereby decreasing the density and increasing the porosity of the ammonium nitrate particles, thereby preparing technical grade ammonium nitrate particles.

In one embodiment according to the system of the disclosure, the system further comprises a hydration system for hydrating the standard grade ammonium nitrate particles with an aqueous solution.

In one aspect of the disclosure, the use of the system of the disclosure for performing the method of the disclosure is disclosed.

In one aspect of the disclosure, the use of a microwave heating system for preparing ammonium nitrate particles having a density ranging from 650.0 g/l to 850.0 g/l and a porosity ranging from 6.0% to 14.0% from providing ammonium nitrate particles having a density above 850.0 g/l and having a porosity below 6.0%, is disclosed.

In one aspect of the disclosure, the use of a microwave heating system for preparing ammonium nitrate particles having a density ranging from 650.0 g/l to 850.0 g/l and a porosity ranging from 6.0% to 14.0% from providing ammonium nitrate particles having a density above 850.0 g/l and having a porosity below 6.0%, is disclosed.

In one aspect of the disclosure, a method for revamping an ammonium nitrate production facility is disclosed. The ammonium nitrate facility comprises a reactor for reacting ammonia and nitric acid, thereby producing an ammonium nitrate solution; an evaporator for evaporating the ammonium nitrate solution, thereby producing an ammonium nitrate melt; a particulation system for particulating the ammonium nitrate melt, thereby providing solid ammonium nitrate particles; a dryer for drying the ammonium nitrate particles; and a cooler for reducing the temperature of the ammonium nitrate particles. The method for revamping comprises the step of replacing the dryer and the cooler with a microwave heating system.

### DETAILED DESCRIPTION

Throughout the description and claims of this specification, the words “comprise” and variations thereof mean “including but not limited to”, and they are not intended to (and do not) exclude other moieties, additives, components, integers or steps. Throughout the description and claims of this disclosure, the singular encompasses the plural unless the context otherwise requires. In particular, where the indefinite article is used, the disclosure is to be understood as contemplating plurality as well as singularity, unless the context requires otherwise.

Features, integers, characteristics, compounds, chemical moieties, or groups described in conjunction with a particular aspect, embodiment or example of the disclosure are to be understood to be applicable to any other aspect, embodiment or example described herein unless incompatible therewith. All of the features disclosed in this disclosure (including the description, claims, abstract and drawing), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this disclosure (including the description, claims, abstract and drawing), or to any novel one, or any novel combination, of the steps of any method or process so disclosed.

The enumeration of numeric values by means of ranges of figures comprises all values and fractions in these ranges, as well as the cited end points. The terms “ranging from . . . to . . . ” or “range from . . . to . . . ” or “up to” as used when referring to a range for a measurable value, such as a parameter, an amount, a time period, and the like, is intended to include the limits associated to the range that is disclosed. Where the term “about” when applied to a particular value or to a range, the value or range is interpreted as being as accurate as the method used to measure it.

In one aspect of the disclosure, a method for producing ammonium nitrate particles having a density ranging from 650.0 g/l to 850.0 g/l and a porosity ranging from 6.0% to 14.0%, is disclosed. The method comprises the steps of a) providing ammonium nitrate particles comprising at least 0.350% by weight of water, having a density above 850.0 g/l, in particular above 900.0 g/l and more in particular ranging from 950.0 g/l to 1050.0 g/l, and having a porosity below 6.0%; and b) heating the ammonium nitrate particles using microwave energy with a frequency ranging from 300.0 MHz to 300.0 GHz, preferably ranging from 915.0 MHz to 22.0 GHz, thereby decreasing the density and increasing the porosity of the ammonium nitrate particles.

The inventor has realised that electromagnetic radiation resulting in the generation of microwaves results in steam generation which in turn results in the creation of pores at the surface and inside the ammonium nitrate particles submitted to microwave treatment. Indeed, water at the surface, and inside the core of the solid ammonium nitrate particles subjected to microwave treatment, not only vaporizes as in many food industry applications but creates new pores when it violently escape from the core to the surface of the solid ammonium nitrate particles.

Microwaves can penetrate solids from 1.0 cm to several centimeters. This means that the microwave energy, in contrast with convection heat provided at the surface of the granules and then being conveyed to the core of the particle through conduction, as is the case in the production of porous ammonium nitrate prills or granules, can directly heat both the surface and the core of the particles. Therefore, water is liberated from the particles rapidly, leading to the rapid formation of pores, within 20 minutes. Hence, the use of microwave energy allows for a reduced reaction time compared to the conventional technologies.

The energy given by the microwave not only generates porosity but further ensures that the ammonium nitrate particles are sufficiently dried which reduces the caking of the porous particles and facilitates their handling and storage.

Further, less dust is produced during the production itself of the porous particles and the size of the dust abatement system present in standard production systems of porous ammonium nitrate can be reduced, which simplifies the system and reduces the system. This is because the microwave treatment can be performed in the absence of rotation, as in the case in conventional granulators such as fluid beds, drum granulators, blungers and spheroidizers, and fall from height, as is the case in prilling. As the method of the disclosure, when in operation, allows for the control of the water present inside the porous particles through the control of the operating pressure, temperature, frequency of the microwave energy generated, the amount of water introduced in the heating step, both through the ammonium nitrate particles as well as in the air introduced in the heating step, as well as the time length of the heating step, it is possible to control the size, the distribution at the surface and inside the particles, and the homogeneity—that is the size distribution—of the pores that are created. Hence the method allows for a controlled operation, in order to control the porous particles that are produced, such that the amount of dust emitted from the particles is in turn controlled, such that the presence of a dust abatement system can even be eliminated.

In addition, water inside the ammonium nitrate particles is not free but comprised in an ammonium nitrate saturated solution. This means that the boiling temperature of the solution within the solid increases progressively as water evaporates from the ammonium nitrate particles. Not only are the porous particles sufficiently dry as mentioned above, it has also been found that the evaporation of water being violent, it does not allow time for heat to be transferred from water evaporating to the ammonium nitrate particles. Consequently, the temperature rise of the ammonium nitrate particles in the system is limited. Therefore, the produced particles are safe and not susceptible to decomposition and detonation.

Nonetheless, any conventional drying and cooling can be installed downstream of the heating step if the requirements for the water content and temperature of the product necessitate it.

Overall, the reduction of the reaction time and the simplification of the conventional system result in a less energy consuming system and allows for the production of porous ammonium nitrate particles, the size, the distribution at the surface and the homogeneity of the pores, the water content and the temperature of which are controlled.

The electromagnetic radiation generated by the microwave oven preferably ranges from 915 MHz to 22 GHz.

The microwave oven of the system is capable of generating electromagnetic radiation in any frequency range that results in the alignment of the dielectric ammonium nitrate particles, such that, submitted to an electric field, they align and re-orient themselves as a result of the rapidly varying electric field. This rapid change in orientation results in the molecules entering in collision with each other, providing each molecule with kinetic energy, which is converted into heat causing water evaporation.

Typical consumers food microwave emits waves at 2.45 GHz, that is a wavelength of 12.2 cm which is absorbed principally by water. As water shows many absorption pics as a function of the wavelength, other microwave frequency band can be used, such as large, industrial microwave ovens generating waves with a 915 MHz, corresponding to a wavelength of 32.8 cm. In the vapor phase, water absorbs at around 22 GHz. Hence the more specific frequency range 915 MHz to 22 GHz is optimal to ensure absorption by the water molecule which is then excited and evaporates.

In one embodiment according to the method of the disclosure, the method further comprises the step of hydrating the ammonium nitrate particles with an aqueous solution prior to the heating step, thereby increasing the water content of the ammonium nitrate particles to a percentage of water above 0.350% by weight.

When the ammonium nitrate particles which serve as the starting material contain only 0.350% by weight of water, it may be advantageous, for optimal pore formation to increase the water content to above 0.350% by weight.

The amount of water that is present in the heating step is defined here to comprise the water both inside and outside the ammonium nitrate particles, and impacts the amount of water present in the gas and liquid phase, and the amount of water that can be absorbed by the ammonium nitrate particles for the creation of pores—that is the amount of water that can be absorbed by the ammonium nitrate starting particles or re-absorbed by porous ammonium nitrate particles. Indeed, steam generated in the core of the particles and expelled from the particles may then condense outside the particles, through releasing heat to the surrounding crystals. The condensed water may in turn be absorbed by ammonium nitrate particles and evaporated, resulting in additional pore formations, increasing the number of pores onto porous particles.

Hence, controlling this amount of water results in controlling the pore formation onto and inside the ammonium nitrate particles. Further, controlling the amount of water during the heating step results in controlling the caking of the ammonium nitrate particles and the clogging inside the oven. The inventor has observed that it is optimal that the water amount does not exceed 5.0% by weight of the ammonium nitrate particles submitted to the heating step such that the caking of the ammonium nitrate particles being heated is minimised.

The amount of water can be controlled through several parameters of the heating step, namely the mass flow of the ammonium nitrate particles in and out of the heating step, as well as the water content of those ammonium nitrate particles, the temperature controlled through the frequency generated by the electromagnetic radiation, the pressure, a flow of incoming air and a flow of gas out, as well as the time length of the heating step.

In one embodiment according to the method of the disclosure, the temperature of the ammonium nitrate particles during the heating step is maintained between 20.0° C. to 50.0° C.

It is beneficial to retain a temperature such that both condensation of water but also temperatures at which the ammonium nitrate particles may decompose are avoided, thus increasing the safety of the process. Such a regime is of particular interest to achieve ammonium nitrate particles that are both non-caking and at the proper temperature. When the process is controlled in this way, neither the drying nor the cooling steps subsequent to the formation of porous ammonium nitrate are required. It has been found particularly beneficial to perform the heating step at a temperature ranging from 20.0° C. to 50.0° C.

In one embodiment according to the method of the disclosure, the duration of the heating step ranges between 10 seconds and 20 minutes.

As mentioned above water at the surface, and inside the core of the solid ammonium nitrate particles subjected to microwave treatment creates new pores when it violently escape from the core to the surface of the solid ammonium nitrate particles. Therefore, pores are created rapidly, within 20 minutes and the reaction time is reduced. It has been found that performing the heating step from 10 seconds to 20 minutes results in the formation of porous ammonium nitrate particles with optimal pore size, pore distribution onto and inside the particle, and also uniformity in the distribution size of the pores.

In one embodiment according to the method of the disclosure, the heating step occurs in a continuous or a batchwise or discontinuous manner.

The method of the disclosure offers the flexibility to operate in a batch or in a continuous manner, thus enabling adjustment to the production needs.

The method of the disclosure further allows for the starting the heating step at low power for allowing time to allow water to better homogenize onto and inside the ammonium nitrate particles and time for conduction, in order to carry heat to the water molecules. In particular, if the water is supplied in such that it is sprayed onto the surface of the granule and not enough time is allowed for homogenization, the deposition of energy will be concentrated on the surface causing it to reach higher temperature, which in turn would give porosity only on the external crust. Increasing the reaction time for allowing water homogenisation is, in this case, beneficial.

Hence the frequency of the radiation can be alternated and needs not be constant. This implies, from a system point of view, that throughout the heating step, the ammonium nitrate particles can be subjected to a range of, thus, varying frequencies that can be supplied throughout the distribution, in the system, of multiple magnetrons, generating the corresponding range of waves frequencies through electromagnetic radiation.

The person skilled in the art will without difficulty optimize, for the heating step, the number of magnetrons and their position, as well as the mass flow of the ammonium nitrate particles to and out the microwave oven, the water content of those ammonium nitrate particles, the supply of water, the temperature, the pressure and the flows of the incoming air and of the gas out, in order to achieve the desired ammonium nitrate particles.

In one embodiment according to the method of the disclosure, the heating step occurs under vacuum or under atmospheric pressure conditions.

When the process is performed under vacuum or atmospheric conditions, the boiling point of water is optimised and minimised, such that the evaporation of water from and the creation of pores inside and onto the ammonium nitrate particles is favoured.

In one embodiment according to the method of the disclosure, the method further comprises the steps of A1) reacting ammonia and nitric acid in a reactor, thereby producing an ammonium nitrate solution; A2) evaporating the ammonium nitrate solution, thereby producing an ammonium nitrate melt; and A3) particulating the ammonium nitrate melt, thereby generating ammonium nitrate particles having a density above 850.0 g/l, in particular above 900.0 g/l and more in particular ranging from 950.0 g/l to 1050.0 g/l, and having a porosity below 6.0%. In a further embodiment, the steps A1), A2) and A3) occur prior to the steps a) and b).

Conventional processes for producing ammonium nitrate comprise a reaction step between ammonia and nitric acid, an evaporating step concentrating the melt produced in the reactor, and a particulation step, that is a priling or a granulating step, for producing ammonium nitrate with a density above 850 g/l, in particular above 900.0 g/l and more in particular ranging from 950.0 g/l to 1050.0 g/l. Hence it is particularly convenient to combine the method of the disclosure to such conventional methods, especially considering the flexibility of the method in terms of the particle size for the ammonium nitrate particles starting material: as explained above, both prills and granules are suitable for the purpose, which means that the conventional method to which the method of the disclosure is combined can comprise either a prilling or a granulating step. In some embodiments, such conventional method precedes the method of the disclosure.

In one embodiment according to the system of the disclosure, during the heating step an incoming air flow is used to control the temperature.

As mentioned above, the amount of water can be controlled through several parameters of the heating step, including the flow of the incoming air, which in turn results in the control of the temperature during the heating step.

The method of the disclosure further provides that the ammonium nitrate particles comprise between 33.0% and 35.0% by weight of nitrogen. Such nitrogen content means that the ammonium nitrate particles can contain a stabilizer or a filler to improve the physicochemical properties of the particles.

Such nitrogen content further corresponds not only to the ammonium nitrate prills used in ammonium nitrate production, it also comprises the nitrogen content of granular ammonium nitrate particles which are, as mentioned above, suitable for use in the system of the disclosure as they are penetrated by the microwaves generated from the operation of the system.

In one embodiment according to the system of the disclosure, the ammonium nitrate particles comprise between 0.30 to 0.50% by weight of a metal.

The presence of a metallic additive results in improved transmission of the energy, that is heat, to the water molecules inside the ammonium nitrate particles, in turn resulting in improved water evaporation from the particles and, thereby, improved creation of pores. Examples of metals include but are not limited to aluminium, magnesium, silica, iron and combinations thereof.

In one aspect of the disclosure, a system for preparing technical grade ammonium nitrate particles having a density ranging from 650.0 g/l to 850.0 g/l and a porosity ranging from 6.0% to 14.0%, is disclosed. The system comprises a reactor for reacting ammonia and nitric acid, thereby providing an ammonium nitrate solution; an evaporator for evaporating the ammonium nitrate solution and producing an ammonium nitrate melt; and a particulation system for particulating the ammonium nitrate melt and providing standard grade ammonium nitrate particles having a density above 850.0 g/l, in particular above 900.0 g/l and more in particular ranging from 950.0 g/l to 1050.0 g/l, and having a porosity below 6.0%.

The system is characterised in that it further comprises a microwave heating system for heating the standard grade ammonium nitrate particles using electromagnetic radiation and providing microwave energy with a frequency ranging from 300.0 MHz to 300.0 GHz, preferably ranging from 915.0 MHz to 22.0 GHz, thereby decreasing the density and increasing the porosity of the ammonium nitrate particles, thereby preparing technical grade ammonium nitrate particles having a density ranging from 650.0 g/l to 850.0 g/l and a porosity ranging from 6.0% to 14.0%.

As used herein, standard grade ammonium nitrate particles are to be understood as ammonium nitrate particles with a density above 850.0 g/l and a porosity below 6.0%, preferably a porosity ranging from 0.1 to 4.0%.

As used herein, technical grade ammonium nitrate particles are to be understood as ammonium nitrate particles with a density ranging from 650.0 g/l to 850.0 g/l and a porosity ranging from 6.0% to 14.0%.

The inventor has realised that electromagnetic radiation resulting in the generation of microwaves results in steam generation which in turn results in the creation of pores at the surface and inside the ammonium nitrate particles submitted to microwave treatment. Indeed, water at the surface, and inside the core of the solid ammonium nitrate particles subjected to microwave treatment, not only vaporizes as in many food industry applications but creates new pores when it violently escape from the core to the surface of the solid ammonium nitrate particles.

Microwaves can penetrate solids from 1.0 cm to several centimeters. This means that the microwave oven, in contrast with convection heat provided at the surface of the granules and then being conveyed to the core of the particle through conduction, as is the case in the production of porous ammonium nitrate prills or granules, can directly heat both the surface and the core of the particles. Therefore, water is liberated from the particles rapidly, leading to the rapid formation of pores, within 20 minutes. Hence, the use of a microwave heating system allows for a reduced reaction time compared to the conventional technologies.

The energy given by the microwave heating system not only generates porosity but further ensures that the ammonium nitrate particles are sufficiently dried which reduces the caking of the porous particles and facilitates their handling and storage.

Further, less dust is produced during the production itself of the porous particles and the size of the dust abatement system present in standard production systems of porous ammonium nitrate can be reduced, which simplifies the system and reduces the system. This is because the microwave treatment can be performed in the absence of rotation, as in the case in conventional granulators such as fluid beds, drum granulators, blungers and spheroidizers, and fall from height, as is the case in prilling. Overall, the system allows for a less energy consuming process, through the reduction of the reaction time and the simplification or elimination of the drying and cooling steps, as well as the production of porous ammonium nitrate particles, the size, the distribution at the surface and inside the particles and the homogeneity of the pores, the water content and the temperature of which are controlled.

In one embodiment according to the system of the disclosure, the system further comprises a hydration system for hydrating the standard grade ammonium nitrate particles with an aqueous solution.

When the ammonium nitrate particles which serve as the starting material contain only 0.350% by weight of water, it may be advantageous, for optimal pore formation to increase the water content to above 0.350% by weight.

The amount of water that is present in the heating step is defined here to comprise the water both inside and outside the ammonium nitrate particles, and impacts the amount of water present in the gas and liquid phase, and the amount of water that can be absorbed by the ammonium nitrate particles for the creation of pores—that is the amount of water that can be absorbed by the ammonium nitrate starting particles or re-absorbed by porous ammonium nitrate particles. Indeed, steam generated in the core of the particles and expelled from the particles may then condense outside the particles, through releasing heat to the surrounding crystals. The condensed water may in turn be absorbed by ammonium nitrate particles and evaporated, resulting in additional pore formations, increasing the number of pores onto porous particles.

Hence, controlling this amount of water results in controlling the pore formation onto and inside the ammonium nitrate particles. Further, controlling the amount of water during the heating step results in controlling the caking of the ammonium nitrate particles and the clogging inside the oven. The inventor has observed that it is optimal that the water amount does not exceed 5% by weight of the ammonium nitrate particles submitted to the heating step such that the caking of the ammonium nitrate particles being heated is minimised.

Therefore, the presence of a hydration system in the system of the disclosure allows for the control of the water in the microwave heating system and, thereby, the control of the pores of the technical ammonium nitrate product.

In one aspect of the disclosure, the use of the system of the disclosure for performing the method of the disclosure is disclosed.

In one aspect of the disclosure, a method for revamping an ammonium nitrate production facility is disclosed. The ammonium nitrate production facility comprises a reactor for reacting ammonia and nitric acid, thereby producing an ammonium nitrate solution; an evaporator for evaporating the ammonium nitrate solution, thereby producing an ammonium nitrate melt; a particulation system for particulating the ammonium nitrate melt, thereby providing solid ammonium nitrate particles; a dryer for drying the ammonium nitrate particles; and a cooler for reducing the temperature of the ammonium nitrate particles. The revamping method comprises the step of replacing the dryer and the cooler with a microwave heating system.

Due to the control of the temperature and amount of water inside the system of the disclosure, it is possible to produce ammonium nitrate particles without the conventional drying and cooling steps are eliminated.

### EXAMPLE

The experiment was performed using a straight ammonium nitrate fertiliser comprising 949 kg/t of ammonium nitrate, 30 kg/t of ammonium sulfate 30 kg/t, 6 kg/t of dolomite, 10 kg/t of clay, 1 kg/t of talcum, 1 kg/t of a coating oil and 3.5 kg/t of water. 300 g of the fertiliser was treated for 24 hours in a static chamber at a controlled relative humidity of 80%. The water content of the product was then measured to be 1.9% by weight.

The sample was poured in a transparent, 250 ml graduated cylindric flask, weighed before the pouring of the sample. The measured volume was adjusted to 250 ml. The cylinder then was weighed and an untapped density of 1005 g/l was calculated for the sample inside the cylinder.

The sample then was submitted to microwave heating treatment in a commercial microwave of 2.45 GHz, equipped with rotating plate. The microwave was operated at a constant power of 500 W for 35 s. The untapped density of the resulting product was measured to be 820 g/l. The water content of the product was also measured using the Karl Fisher method and determined to be 0.21% by weight. Finally, the temperature of the product was determined to be 30° C.

The porosity of the sample was measured by pouring the sample for 1 hour in an oil, which was then let to drain for 2 hours. The sample then was rolled on an absorbing paper until no colour was visible on the paper. The porosity of the resulting sample was determined to be 6.3%.

1.-15. (canceled)

16. A method for producing ammonium nitrate particles having a density ranging from 650.0 g/l to 850.0 g/l and a porosity ranging from 6.0% to 14.0%, comprising steps of:
a) providing ammonium nitrate particles comprising at least 0.350% by weight of water, having a density above 850.0 g/l and having a porosity below 6.0%; and
b) heating the ammonium nitrate particles using microwave energy wherein a frequency ranging from 300.0 MHz to 300.0 GHz is applied and wherein the heating step is performed at a temperature ranging from 20.0° C. to 50.0° C., thereby decreasing the density and increasing the porosity of the ammonium nitrate particles.

17. The method according to claim 16, wherein the microwave energy has a frequency range from 915.0 MHz to 22.0 GHz.

18. The method according to claim 16, wherein the microwave energy has a frequency range from 915.0 MHz to 2.45 GHz.

19. The method according to claim 16, wherein the microwave energy has a frequency of 915.0 MHz or 2.45 GHz.

20. The method according to claim 16, wherein the microwave energy has a frequency of 2.45 GHz.

21. The method according to claim 16, further comprising the step of hydrating the ammonium nitrate particles with an aqueous solution prior to the heating step, thereby increasing the water content of the ammonium nitrate particles to a percentage of water above 0.350% by weight.

22. The method according to claim 16, wherein the temperature of the ammonium nitrate particles during the heating step is maintained between 20.0° C. to 50.0° C.

23. The method according to claim 16, wherein a duration of the heating step ranges between 10 seconds and 20 minutes.

24. The method according to claim 16, wherein the heating step occurs in a continuous or a batchwise or discontinuous manner.

25. The method according to claim 16, wherein the heating step occurs under vacuum or under atmospheric pressure conditions.

26. The method according to claim 16, further comprising the steps of:
A1) reacting ammonia and nitric acid in a reactor, thereby producing an ammonium nitrate solution;
A2) evaporating the ammonium nitrate solution, thereby producing an ammonium nitrate melt; and
A3) particulating the ammonium nitrate melt, thereby generating the ammonium nitrate particles having a density above 850.0 g/l and having a porosity below 6.0%.

27. The method according to claim 16, wherein during the heating step an incoming air flow is used to control the temperature.

28. The method according to claim 16, wherein the ammonium nitrate particles provided in step a) comprise between 33.0% and 35.0% by weight of nitrogen.

29. The method according to claim 16, wherein the ammonium nitrate particles provided in step a) comprise between 0.30 to 0.50% by weight of a metal.

30. A system for preparing technical grade ammonium nitrate particles having a density ranging from 650.0 g/l to 850.0 g/l and a porosity ranging from 6.0% to 14.0% comprising:
a reactor for reacting ammonia and nitric acid, thereby providing an ammonium nitrate solution;
an evaporator for evaporating the ammonium nitrate solution and producing an ammonium nitrate melt; and
a particulation system for particulating the ammonium nitrate melt and providing standard grade ammonium nitrate particles having a density above 850.0 g/l and having a porosity below 6.0%;
characterized in that the system further comprises a microwave heating system configured for heating the standard grade ammonium nitrate particles using electromagnetic radiation to a temperature ranging from 20.0° C. to 50.0° C. and configured for providing microwave energy with a frequency ranging from 300.0 MHz to 300.0 GHz, thereby decreasing the density and increasing the porosity of the ammonium nitrate particles, thereby preparing technical grade ammonium nitrate particles.

31. The system according to claim 30, wherein the microwave heating system is configured to provide microwave energy with a frequency range from 915.0 MHz to 22.0 GHz.

32. The system according to claim 30, wherein the microwave heating system is configured to provide microwave energy with a frequency range from 915.0 MHz to 2.45 GHz.

33. The system according to claim 30, wherein the microwave heating system is configured to provide microwave energy with a frequency of 915.0 MHz or 2.45 GHz.

34. The system according to claim 30, wherein the microwave heating system is configure to provide microwave energy with a frequency of 2.45 GHz.

35. The system according to claim 30, further comprising a hydration system configured for hydrating the standard grade ammonium nitrate particles with an aqueous solution.

36. The system according to claim 30, configured to perform a method for producing the ammonium nitrate particles having the density ranging from 650.0 g/l to 850.0 g/l and the porosity ranging from 6.0% to 14.0%, comprising steps of:
a) providing ammonium nitrate particles comprising at least 0.350% by weight of water, having a density above 850.0 g/l and having a porosity below 6.0%; and
b) heating the ammonium nitrate particles using the microwave energy wherein a frequency ranging from 300.0 MHz to 300.0 GHz is applied and wherein the heating step is performed at a temperature ranging from 20.0° C. to 50.0° C., thereby decreasing the density and increasing the porosity of the ammonium nitrate particles.

37. A method for revamping an ammonium nitrate production facility comprising a reactor for reacting ammonia and nitric acid, thereby producing an ammonium nitrate solution; an evaporator for evaporating the ammonium nitrate solution, thereby producing an ammonium nitrate melt; a particulation system for particulating the ammonium nitrate melt, thereby providing solid ammonium nitrate particles having a density above 850.0 g/l and having a porosity below 6.0%; a dryer for drying the ammonium nitrate particles; and a cooler for reducing a temperature of the ammonium nitrate particles, wherein the dryer and the cooler are replaced with a microwave heating system, wherein the microwave heating system provides microwave energy with a frequency ranging from 300.0 MHz to 300.0 GHz at a temperature ranging from 20.0° C. to 50.0° C., thereby forming ammonium nitrate particles having a density ranging from 650.0 g/l to 850.0 g/l and a porosity ranging from 6.0% to 14.0%.

38. The method of claim 37, wherein the microwave energy with a frequency range from 915.0 MHz to 22.0 GHz is applied on the ammonium nitrate particles.

39. The method of claim 37, wherein microwave energy with a frequency of 915.0 MHz or 2.45 GHz is applied on the ammonium nitrate particles.
